(19) United States
(12) Patent Application Publication
(10) Pub. No.: US 2009/0130976 A1
(43) Pub. Date: May 21, 2009

(54) Display Device for Positioning a Tool Against a Workpiece

(76) Inventors: Reiner Krapf, Reutlingen (DE); Michael Mahler, Leinfelden-Echterdingen (DE)

Correspondence Address: MICHAEL J. STRIKER, 103 EAST NECK ROAD, HUNTINGTON, NY, 11743, US

(21) Appl. No.: 11/995,137

(22) PCT Filed: Oct. 30, 2006
(86) PCT No.: PCT/EP06/67936

§ 371 Date: Jan. 9, 2008

(30) Foreign Application Priority Data
Oct. 31, 2005 (DE) 10 2005 052 028.6

(51) Int. Cl. H04B 7/24

(52) U.S. Cl. 455/39

(57) ABSTRACT

The invention relates to a display device for positioning a tool on a workpiece (4), said device comprising a transmitter (2) for emitting a signal (10) that penetrates the workpiece (4) and a receiver for receiving the signal (10). According to the invention, the receiver contains an assembly of sensor elements (8).

### PRIOR ART

The invention is based on a display device for positioning a tool against a workpiece as generically defined by the preamble to claim 1.

In machining a workpiece, such as a wall or a ceiling of a floor in a multi-story building, it can happen that a position specification, for instance for a hole in the ceiling, is made from one side of the ceiling, but drilling cannot be done from that side. The drilling is then done from the other side of the ceiling, and the desired position must also be identified on that side of the ceiling. For that purpose, display devices with a transmitter device are known, the transmitter device being secured at the predetermined position on the side of the wall or ceiling from which drilling cannot be done. The transmitter device transmits a transmission signal through the wall, for instance. With the aid of a mobile receiver, the corresponding desired position is looked for on the machining side of the wall; the position is marked there; and the hole, for instance, is then drilled at that position.

### ADVANTAGES OF THE INVENTION

The invention is based on a display device for positioning a tool against a workpiece, having a transmitter for transmitting a signal that penetrates the workpiece and having a receiver for receiving the signal.

It is proposed that the receiver include an array of sensor elements. Moving an individual receiver around on the side of the workpiece diametrically opposite the transistor can be dispensed with, and a desired position, or a location to be ascertained, can be ascertained simply and displayed, for instance on a digital display, or directly by means of one or more lamps. For that purpose, the array can be secured to the side of the workpiece—such as the wall—diametrically opposite the transmitter, and the machining site can be read off directly from the desired position.

As the array, a grid array is advantageous, for instance a rectangular grid array. The array expediently includes means for securing it to the workpiece, such as adhesive means. The display device serves the purpose of indirectly or directly displaying a desired position. The workpiece is then advantageously located between the transmitter and the receiver. For the transmission, the transmitter can feed electromagnetic waves in the kilohertz, megahertz or gigahertz range, in the form of modulated signals or magnetic fields or electrical fields, into the workpiece. The frequency ranges possible include all the allocatable radio bands (ISM bands). A so-called UWB (ultra wide band) transmitter is especially advantageous; it transmits a very wide band signal, for instance in the form of one or more pulses, in a frequency range between 500 MHz and 20 GHz. In this kind of operation, only a very low transmission power is necessary, since interference of individual frequencies is harmless. Moreover, large quantities of data, for instance for evaluating a workpiece thickness or a workpiece material, can be sent and received quickly. In addition, a plurality of sensors can be addressed quickly and individually by means of suitable signal components. As an alternative to a transmitter intended for a pulsed mode of operation, a CW or PN radar may advantageously be employed. In CW (Continuous Wave) radar, a frequency ramp is emitted and a reflected frequency is compared with a frequency that has just been emitted. In PN (pseudo noise) radar, a continuous noise is generated, and a desired signal is placed over the noise.

As the transmitter, a permanent magnet, electromagnet, coil, capacitor array, or an array for generating electrical field peaks can be used for generating the signals. When electromagnetic waves are used as a transmission signal and antennas in the sensor elements are used, the evaluation of the transmitted signal can be done via the received field intensity. When capacitive surfaces are used, the evaluation can be done by way of the intensity or change in the electrical field. It is equally possible to use surface acoustic waves, in which the evaluation is done by the excitation of resonant structures, for instance in a semiconductor material, and converting them into an electrical signal.

In a preferred embodiment, the sensor elements are so-called RFID (Radio Frequency Identification) elements, since such elements can be produced especially favorably by mass production. Such RFID elements are widely known and are capable of reacting to the transmitted signal with an identification signal whose intensity and signal contents are evaluated by an arithmetic unit. If magnetic waves are used as the transmitted signal, the sensor elements can contain coils, and the evaluation can be done by way of the field intensity received. If a static magnetic field is used, magnetic sensors, such as Hall sensors, can be used, along with the evaluation of the field intensity. If an electrical field is used, electrical field sensors, such as capacitor arrays, can be used, in conjunction with the evaluation of the electrical field intensity or the electric charge.

Securing the array with sensor elements to the workpiece can be done especially simply if the sensor elements are secured in a substrate assembly, in particular at predetermined positions to one another. The sensor elements may be secured in or on the substrate assembly. It is especially advantageous to use a substrate mat, which in particular can be rolled up and in this way transported especially simply, as the substrate assembly.

High local resolution in the search for or display of the desired position, for instance diametrically opposite the transmitter, can be attained if at least one sensor element during a reception operation is movable relative to the substrate assembly. In particular, all the sensor elements secured to the substrate assembly are movable relative to the substrate assembly during a reception operation, expediently on an internal substrate assembly that is movable overall relative to the substrate assembly.

An especially simple display of a location to be ascertained can be attained if the sensor elements have an optical signal means. The luminosity of the signal means is expediently variable essentially continuously, and as a result a field intensity, for instance, can be optically displayed directly.

In a further embodiment of the invention, the display device has an optical signal means which is triggerable by an evaluation unit and is located at a predetermined spacing from the sensor elements. As a result, a location to be ascertain can be displayed essentially independently of the positions of the sensor elements.

If the signal means includes a matrix of signal elements, then the location to be ascertained can be displayed especially simply and precisely.

Particularly if short transmission pulses are employed, it is advantageous if the location to be ascertained is ascertained by an evaluation unit, stored in memory, and displayed. To that end, the display device expediently includes an evaluation unit which is prepared for outputting a location-displaying signal, regardless of an instantaneous transmission operation of the transmitter.

The display device can be embodied especially economically and sturdily if the sensor elements are provided for transmitting the signal through the workpiece. An evaluation unit can be connected to the transmitter, so that the transmitter array does not require any direct connection with the evaluation unit and as a result can be embodied quite simply.

Advantageously, the display device includes an evaluation unit for receiving signals from the sensor elements and at least one coding means for providing a signal from a sensor element with a code associated with that sensor element. As a result, the evaluation unit can distinguish the sensor elements from their codes and can for instance make a determination of the workpiece thickness by ascertaining a relative position of the sensor elements with regard to the transmitter or an additional receiver.

Expediently, the display device includes an evaluation unit which is provided for determining a workpiece thickness from a signal from or to the at least one sensor element, for instance from ascertaining the signal transit time.

The workpiece thickness can be ascertained especially precisely by means of an evaluation unit that is provided for determining a workpiece thickness from a comparison of sensor signals. The sensor signals can be transmitted from the sensor elements, on command by the evaluation unit or for instance by means of excitation of a transmission signal from the transmitter from the sensor elements.

### DRAWINGS

Further advantages will become apparent from the ensuing description of the drawings. In the drawings, exemplary embodiments of the invention are shown. The drawings, description and claims include numerous characteristics in combination. One skilled in the art will expediently consider the characteristics individually as well and put them together to make useful further combinations.

Shown are:

FIG. 1, a schematic illustration of a display device on a wall;

FIG. 2, a substrate assembly of the display device with sensor elements;

FIG. 3, a detail of an alternative display device with a signal element grid;

FIG. 4, a display and evaluation diagram for determining a workpiece thickness;

FIG. 5, a substrate assembly with an internal substrate assembly movable on it; and

FIG. 6, a schematic transmission, reception and evaluation diagram.

### DESCRIPTION OF THE EXEMPLARY EMBODIMENTS

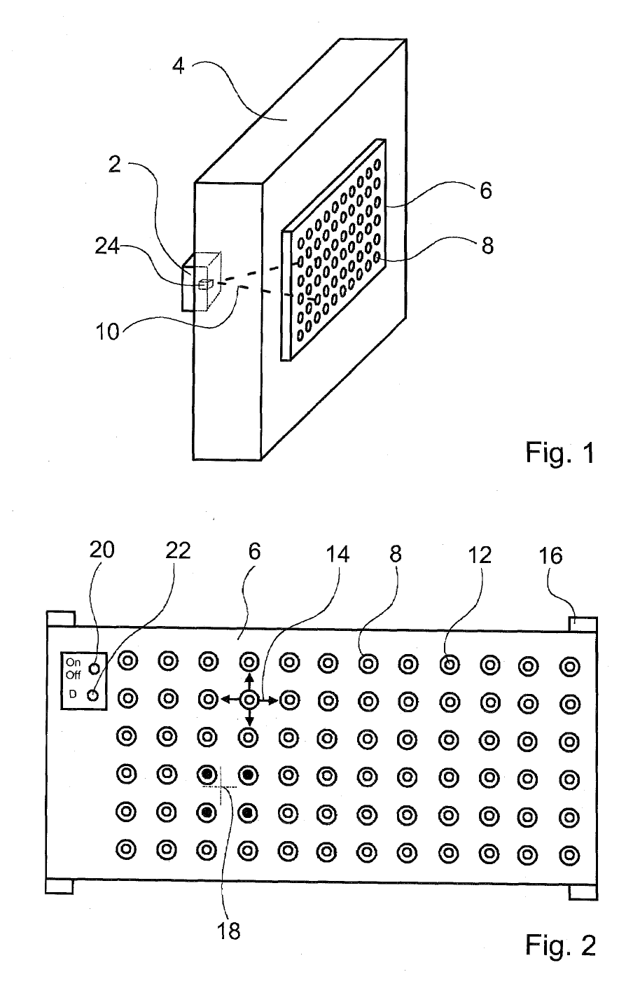

FIG. 1 shows a display device with a transmitter 2, which is positioned and secured to one side of a workpiece 4, embodied as a wall. Opposite the transmitter 2, a substrate assembly 6 with a number of sensor elements 8 is secured to the wall. A signal 10 transmitted by the transmitter is detected by a series of sensor elements 8.

FIG. 2 shows the substrate assembly 6, made from firm cloth as a mat, on which 6×12 sensor elements 8 are secured in such a way that they are each movable relative to the substrate assembly 6 in the direction of arrows 14 to just before the adjacent sensor element 8. Optical signal elements 12 in the form of LEDs are secured to each of the sensor elements 8. The substrate assembly 6 itself has four retention means 16 for securing it to the workpiece 4, which are embodied as easily replaceable adhesive means.

For ascertaining a desired position 18, or a position to be ascertained, that is diametrically opposite the transmitter 2, the transmitter 2 is secured to the workpiece 4 in a transmitting position, in which position, an opening in a wall, driven beforehand from the other side of the workpiece 4, is meant to emerge from the wall. Next, the substrate assembly 6, with the sensor elements 8, is secured to the other side of the workpiece 4, specifically at a point where the desired position 18, which is diametrically opposite the transmitting position of the transmitter 2, is suspected to be. The transmitter is then switched on with the aid of a button 20, and it beams its conical signal 10 into the workpiece 4, and this signal is detected by the sensor elements 8. The sensor elements 8 that detect the signal 10 thereupon send a signal 10 to the particular signal element 12 assigned to them if the signal 10 exceeds the preset signal intensity. In the example shown in FIG. 2, for instance, the four signal elements 12, which are located around the desired position 18, light up. The number of signal elements 12 that light up is essentially dependent on the distance of the substrate assembly 6 from the transmitter 2. The farther away the substrate assembly 6 is from the transmitter 2, the more signal elements 12 are located within the conical signal 10 and accordingly light up. In the case of a very thin wall, it can happen that the conical signal 10 passes between the sensor elements 8 and does not strike any of them. Nevertheless, by a slight shifting of the sensor elements 8 in the direction of the arrows 14, the signal 10 can still be found, and the desired position 18 can be located quite precisely. In the example shown in FIG. 2, by a motion of the signal elements 12, the circular boundary of the signal 10 can furthermore be detected quite precisely by a user, and the desired position 18 can be recognized quite precisely as the center point of this circle.

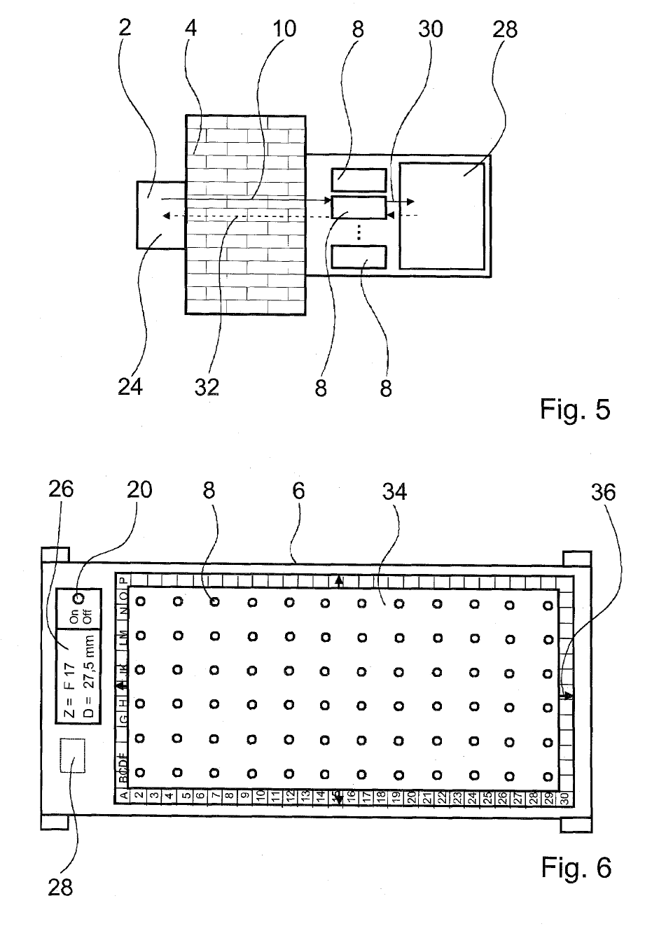

To make it possible to determine a thickness of the workpiece 4 in addition, the display device is equipped with a transmitter device, by means of which the sensor elements 8 each emit a signal 32 (FIG. 5) upon the actuation of a button 22. The transmitter 2, which is prepared for receiving these signals 32 and for evaluating them with the aid of an evaluation unit 24, evaluates the signals 32 of the sensor elements 8 and from that evaluation determines the thickness of the workpiece 4, and this is displayed on a display means, not shown, of the transmitter 2. The thickness can be ascertained in that each sensor element 8 emits a correspondingly encoded signal 32, by means of which the evaluation unit 24 can unambiguously tell the origin of the signal 32. From the difference between the transit times of the signals 32 from the sensor elements 8 to the transmitter 2, the evaluation unit 24, in conjunction with the positions of the sensor elements 8 on the substrate assembly 6 that are known from the encoding, can calculate the distance from the next sensor elements 8. The prerequisite for this is merely that the substrate assembly 6 rest on the workpiece 4 as flatly as possible. If the substrate assembly 6 has a plane orientation, there is no need for synchronization between the sensor elements 8 and the transmitter 2.

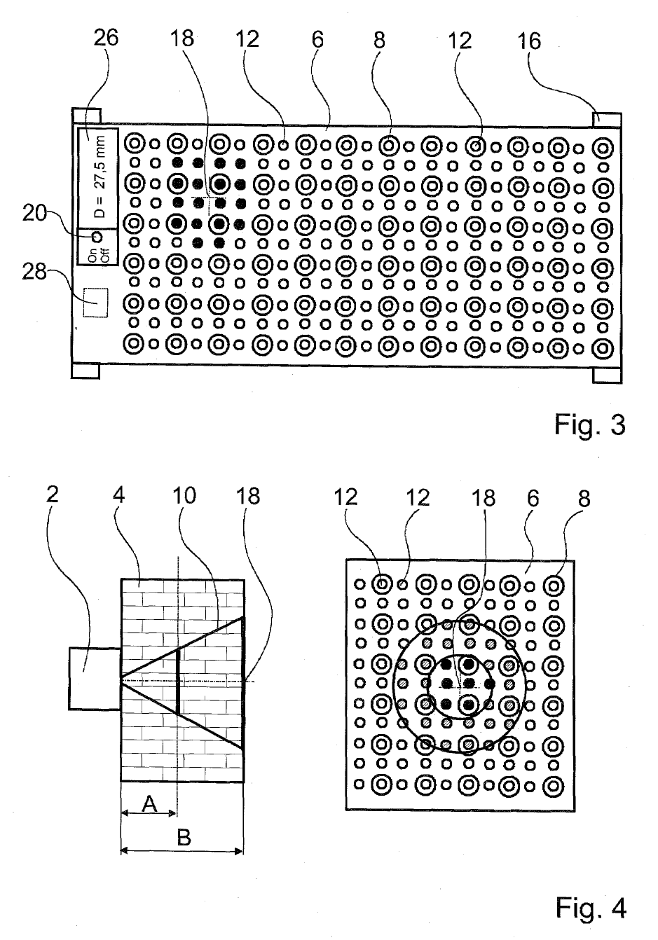

FIG. 3 shows a further substrate assembly 6 of a display device, having a number of sensor elements 8 and signal elements 12 embodied as RFID elements. Components that remain essentially the same are identified throughout by the same reference numerals. With regard to characteristics and functions that remain the same, the description of the exemplary embodiment of FIG. 2 can be referred to; the ensuing description will be limited essentially to the differences from the exemplary embodiment of FIG. 2. The sensor elements 8 are secured immovably on the substrate assembly 6 and each carry a signal element 12. In addition, further signal elements 12 are secured to the substrate assembly 6 itself. Because of the close positioning of all the signal elements 12, a desired position 18 can be ascertained quite precisely. From the number of signal elements 12 that light up, a user can furthermore estimate the distance of the transmitter 2 from the signal elements 12.

The transmitter 2 transmits its signal 10 in the form of one or more ultrashort, energetically very weak pulses, as a result of which the signal 10 is given an ultra wide frequency range and is largely insensitive to interference. From the number of sensor elements 8 that receive the signal 10, from their position on the substrate assembly 6, and from the signal intensities measured by them, the desired position 18 can be calculated by an evaluation unit 28; this position is stored by the evaluation unit 28 and is displayed, independently of the existence of the signal 10, by the signal elements 12. For outputting the desired position 18 to the user, the evaluation unit 28 can now for instance cause all the signal elements 12 located inside the signal 10 to light up, as is shown in FIG. 3. From the geometry of the entirety of the signal elements 12 that light up, a user can estimate both the location of the desired position 18 and a wall thickness. Alternatively, the evaluation unit 24 triggers only the particular signal element 12 that is located in the immediate vicinity of the desired position 18.

FIG. 4 schematically shows the influence that the workpiece thickness has on the number and distribution of responding sensor elements 8. The signal 10 is beamed conically by the transmitter 2, for instance into a wall. If the wall has a thickness A, then the spatial propagation of the signal 10 is relatively slight, and thus an array of sensor elements 8 mounted on the side of the wall diametrically opposite the transmitter 2 responds only in this small spatial area, with for instance seven sensor elements 8, as shown in FIG. 4. In the case of a thicker wall, with a thickness B, the spatial area of the signal 10 emerging from the wall is substantially greater and encompasses more sensor elements 8, for instance eight sensor elements 8 and thirty-two signal elements 12. From the number of signal elements 12 triggered by the evaluation unit 28, a user—as long as he is familiar with the expansion cone of the signal 10—can estimate the thickness of the wall. If the wall thickness is ascertained electronically, then the evaluation unit 24 can calculate the thickness from the number and location of sensor elements 8 that react and can correspondingly output this thickness to an output unit 26 (FIG. 3).

FIG. 5 schematically shows the display method for displaying the desired position 18 and the ascertainment method for ascertaining the thickness of the workpiece 4. The transmitter 2 feeds the signal 10 into the workpiece 4; the signal 10 passes through the workpiece 4 and is recorded by sensor elements 8. The sensor elements 8 are connected to the evaluation unit 28, which from the signals 30 of the sensor elements 8 ascertains the desired position 8 and optionally the thickness of the workpiece 4. Depending on the exemplary embodiment, the evaluation unit 28 can cause the sensor elements 8 to output further signals 32, which pass through the workpiece 4 and are received by a transmitting antenna of the transmitter 2, which at the same time can be the receiving antenna of the transmitter 2. From this signal 32, the evaluation unit 24 can determine the workpiece thickness.

A further exemplary embodiment is shown in FIG. 6. The substrate assembly 6 has an internal substrate assembly 34, on which the sensor elements 8 are secured immovably. The internal substrate assembly 34 itself, however, is movable in the direction of arrows 36 relative to the substrate assembly 6 and inside it. For ascertaining the desired position 18, the substrate assembly 6 can be positioned on the workpiece 4, and the likewise positioned transmitter 2 can be switched on. A signal cone is recorded by a number of sensor elements 8, whose signal is supplied in turn to the evaluation unit 28. From the number and position of sensor elements 8 that react and from their various reaction times, which result from the varying transit times of the signal 10 from the transmitter 2 to the sensor elements 8 at various distances from the transmitter 2, the evaluation unit 28 calculates the thickness of the workpiece 4 and outputs it at the output unit 26. The evaluation unit 28 furthermore outputs the desired position 18 in the form of coordinates, such as F 17 in FIG. 6. For that purpose, the relative position of the internal substrate assembly 34 with respect to the substrate assembly 6 is known to the evaluation unit 28. The precision with which the desired position 18 can be indicated is dependent on the spacing of the sensor elements 8 from one another.

To increase this precision, a user can now move the internal substrate assembly 34 two-dimensionally back and forth relative to the substrate assembly 6, whereupon the sensor elements 8 receive the signal 10 of the transmitter 2 at multiple intervals or continuously and forward corresponding signals 30 to the evaluation unit 28. From these signals 30 and their variation upon the motion of the internal substrate assembly 34—or the change in the sensor elements 8 that respond—the evaluation unit 28 can ascertain the desired position 18 with very high precision and correspondingly output it at the output unit 26.

### LIST OF REFERENCE NUMERALS

2 Transmitter
4 Workpiece
6 Substrate assembly
8 Sensor element
10 Signal
12 Signal element
14 Arrow
16 Retention means
18 Position
20 Button
22 Button
24 Evaluation unit
26 Output unit
28 Evaluation unit
30 Signal
32 Signal
34 Internal substrate assembly
36 Arrow
A Thickness
B Thickness

1. A display device for positioning a tool against a workpiece (4), having a transmitter (2) for emitting a signal (10) that penetrates the workpiece (4) and having a receiver for receiving the signal (10), characterized in that the receiver includes an array of sensor elements (8).

2. The display device as defined by claim 1, characterized in that the sensor elements (8) are secured in a substrate assembly (6).

3. The display device as defined by claim 2, characterized in that at least one sensor element (8) is movable relative to the substrate assembly (6) during a reception operation.

4. The display device as defined by claim 1, characterized in that the sensor elements (8) have an optical signal means.

5. The display device as defined by claim 1, characterized by an optical signal means which is triggerable by an evaluation unit (28) and is located at a predetermined spacing from the sensor elements (8).

6. The display device as defined by claim 5, characterized in that the signal means includes a matrix of signal elements (12).

7. The display device as defined by claim 1, characterized by an evaluation unit (28), which is prepared for outputting a location-displaying signal independently of an instantaneous transmission operation of the transmitter (2).

8. The display device as defined by claim 1, characterized in that the sensor elements (8) are provided for transmitting a signal (32) through the workpiece (4).

9. The display device as defined by claim 1, characterized by an evaluation unit (24, 28), which for determining a workpiece thickness from a signal (10, 32) from at least one sensor element (8).

10. The display device as defined by claim 1, characterized by an evaluation unit (24, 28), which is provided for determining a workpiece thickness from a comparison of sensor signals.
